(19) United States
(12) Patent Application Publication
(10) Pub. No.: US 2026/0017175 A1
(43) Pub. Date: Jan. 15, 2026

(54) DATA EXCHANGE MANAGER FOR MICROSERVICES

(71) Applicant: Dell Products L.P., Round Rock, TX (US)

(72) Inventors: Lee Chuen Ooi, Singapore (CN); Baturay Mutlu, Austin, TX (US); Mohan Muppalaneni, Round Rock, TX (US)

(73) Assignee: Dell Products L.P., Round Rock, TX (US)

(21) Appl. No.: 18/772,347

(22) Filed: Jul. 15, 2024

(51) Int. Cl. G06F 11/36; G06F 11/30; G06F 11/32

(52) U.S. Cl. CPC G06F 11/3636; G06F 11/3072; G06F 11/323

(57) ABSTRACT

A method, comprising: displaying a first screen for specifying one or more tagging rules for a microservice; receiving, via the first screen, a first user input specifying a tagging rule, the tagging rule including a tag and a tagging condition that needs to be satisfied by an execution trace in order for the respective tag to be appended to the execution trace; displaying a second screen for specifying one or more filtering criteria, the second screen including an input component that is populated with the respective tag; receiving a second user input specifying a filtering condition, the second user input being received, at least in part, via the second screen; and displaying a list of execution traces that satisfy the filtering condition.

### BACKGROUND

Microservice architectures offer numerous advantages, such as the ability to scale independently, flexibility in development and deployment, fault isolation, diverse technological choices, optimized resource utilization, decentralized data management, and the empowerment of specialized teams. On the other hand, Microservices architectures tend to have increased system complexity, increased coordination complexity between teams and increased communication overhead. These challenges become particularly apparent within organizations employing an extensive set of microservices, intricate dependencies, and integrations. However, utilizing innovative management tools can help effectively manage and reduce these complexities, improve visibility into system performance, and streamline team coordination in software development.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to aspects of the disclosure, a method is provided, comprising: displaying a first screen for specifying one or more tagging rules for a microservice; receiving, via the first screen, a first user input specifying a tagging rule, the tagging rule including a tag and a tagging condition that needs to be satisfied by an execution trace in order for the respective tag to be appended to the execution trace; displaying a second screen for specifying one or more filtering criteria, the second screen including an input component that is populated with the respective tag; receiving a second user input specifying a filtering condition, the second user input being received, at least in part, via the second screen; and displaying a list of execution traces that satisfy the filtering condition.

According to aspects of the disclosure, a system is provided comprising: a memory; and at least one processor that is operatively coupled to the memory, the at least one processor being configured to perform the operations of: displaying a first screen for specifying one or more tagging rules for a microservice; receiving, via the first screen, a first user input specifying a tagging rule, the tagging rule including a tag and a tagging condition that needs to be satisfied by an execution trace in order for the respective tag to be appended to the execution trace; displaying a second screen for specifying one or more filtering criteria, the second screen including an input component that is populated with the respective tag; receiving a second user input specifying a filtering condition, the second user input being received, at least in part, via the second screen; and displaying a list of execution traces that satisfy the filtering condition.

A method, comprising: identifying a first execution trace pattern, the first execution trace pattern including a plurality of first execution traces; identifying a second execution trace pattern that matches the first execution trace pattern, the second execution trace pattern including a plurality of second execution traces; extracting at least some of contents of the plurality of second execution traces; and providing the extracted contents to a testing system.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of a system, according to aspects of the disclosure;

FIG. 2 is a diagram illustrating an example of a plurality of microservices, according to aspects of the disclosure;

FIG. 3 is a flowchart of an example of a process, according to aspects of the disclosure;

FIG. 4 is a flowchart of an example of a process, according to aspects of the disclosure;

FIG. 5 is a flowchart of an example of a process, according to aspects of the disclosure;

FIG. 6 is a flowchart of an example of a process, according to aspects of the disclosure;

FIG. 7A is a diagram of an example of a user interface, according to aspects of the disclosure;

FIG. 7B is a diagram of an example of a user interface, according to aspects of the disclosure;

FIG. 7C is a diagram of an example of a user interface, according to aspects of the disclosure;

FIG. 7D is a diagram of an example of a user interface, according to aspects of the disclosure;

FIG. 7E is a diagram of an example of a user interface, according to aspects of the disclosure;

FIG. 7F is a diagram of an example of a user interface, according to aspects of the disclosure;

FIG. 7G is a diagram of an example of a user interface, according to aspects of the disclosure;

FIG. 7H is a diagram of an example of a user interface, according to aspects of the disclosure;

FIG. 7I is a diagram of an example of a user interface, according to aspects of the disclosure;

FIG. 8 is a diagram of an example of a computing device, according to aspects of the disclosure.

### DETAILED DESCRIPTION

In a distributed computing environment, a critical aspect involves the interchanged data between applications. These data serve as the inputs and outputs of integration points. Failure to understand the contents of the exchanged data limits the overall visibility of the entire system behavior and hinders effective root cause analysis in the event of system failures. As solutions, individual application teams often resort to leveraging Application Performance Monitoring (APM) tools, crafting custom application logs, and consulting pre-existing documentation. However, these solutions introduce additional overheads and complexities.

These challenges collectively underscore the need for a streamlined, standardized, and efficient solution that can address the limitations posed by existing tools and practices, providing a cohesive framework for end-to-end analysis across diverse application teams.

Despite their value in various aspects, APM tools encounter challenges when it comes to capturing message content comprehensively. These tools often resort to sampling traces or imposing constraints on content size, resulting in the generation of incomplete datasets. Additionally, APM tools primarily concentrate on the dependencies between applications and services, typically overlooking the capture of request and response contents. The absence of this critical information hinders their ability to offer analytics on how applications behave in response to different types of request content. This limitation emphasizes the necessity for a more holistic approach that includes comprehensive content capture for a nuanced understanding of application behavior across various scenarios.

Custom logging, an approach frequently adopted by application teams, lacks standardization. Each team operates independently, implementing unique logging practices. This inconsistency complicates insights and may lead to performance overheads.

In instances where custom logging practices are absent, teams resort to replicating calls and capturing requests using network monitoring tools. However, this workaround proves insufficient, as it fails to yield accurate results. The replication process does not precisely emulate the execution that occurred at an earlier point in time, rendering the captured data less reliable for comprehensive analysis. It impacts the efficiency of analysis.

In distributed systems, application behavior varies with request payloads. For example, the same microservice route may behave differently depending on the request it receives. APM tools struggle to identify similar requests and predict service behaviors, requiring teams to invest time in custom logging for tagging and information extraction, leading to extra development and potential bugs.

Considering the problems discussed above, a data exchange manager is provided to capture, observe, and analyze exchanged data, to predict application behaviors. In addition, the data exchange manager may generate request payloads for automated testing and provide comprehensive and accurate data that could be utilized in diagnosing and resolving various issues. With the help of the data exchange manager, application teams can save a significant amount of time that would otherwise be spent on debugging, log investigation, team communication, and working sessions. The data collected by the data exchange manager can be used to identify edge cases that are not properly handled and to understand the dependencies and flows between applications.

Using the data exchange manager can lead to an increase in the efficiency of application teams, as they would be able to identify issues and resolve them much faster than before. This, in turn, can lead to an increase in customer satisfaction, as issues are resolved in a timely and efficient manner.

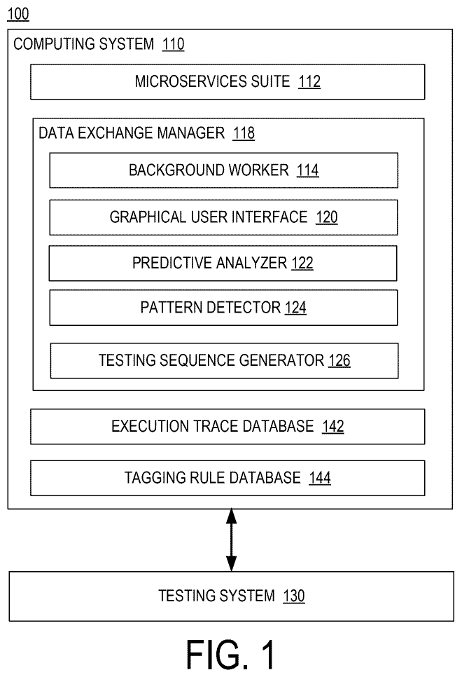

In another aspect, the data exchange manager provides end-to-end tracing capability, providing easy access to traces on a UI. In another example, the data exchange manager may include a package, a web application programming interface (API), and a user interface. The package may be the component that helps applications integrate with the data exchange manager. The package, when installed, may cause a plurality of background workers to be installed in different systems. Each of the background workers may be the same or similar to background worker 114, which is discussed further below with respect to FIG. 1.

Applications consume this package and configure their startup configuration to enable trace collection as a result. This package may listen to request events and capture one or more of the following types of trace data: (a) Request details, body, and headers, (b) Returned response details, body, and headers; (c) Outgoing request details, body, and headers; (d) Response details, body, and headers of outgoing requests; and (e) Logs. In addition, the package may be configured to send any of the collected trace data to a Web API. In one example, the package may be configured to return, to the Web API, a response header containing a URL that points to the captured trace data. In one ex

The Web API may be configured to provide important components of the functionality of the data exchange manager. In some implementations, the Web API may normalize and save trace data collected from the applications that consumed the package, execute trace processing and tagging rules, and/or purge the trace data based on the data retention settings. Additionally or alternatively, in some implementations, the Web API may contain the methods to provide User Interface functionality like trace searching, authentication, and data exporting. Additionally or alternatively, in some implementations, the Web API may be arranged to provide configurable notifications and alerts for data exchange insights that are generated by the Web API. The data exchange insights may be generated by processing trace data that is collected by the package. The data exchange insights may include one or more of: (i) an indication of a trend that is identified based on trace data, a prediction that is generated based on trace data. Additionally or alternatively, in some implementations, the Web API may auto-generate various new request payloads for specific business contexts, using historical request payloads. The generated data could be used in regression testing. In one example, the Web API may include a predictive analyzer 122, a pattern detector 124, and a testing sequence generator 126, all of which are discussed further below with respect to FIG. 1.

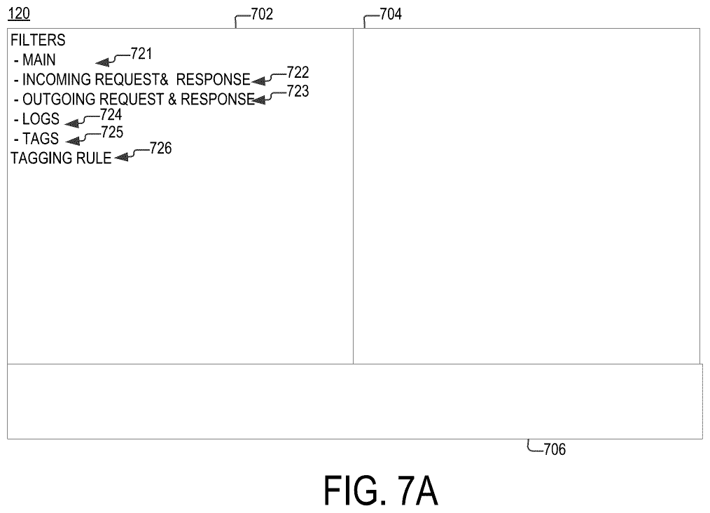

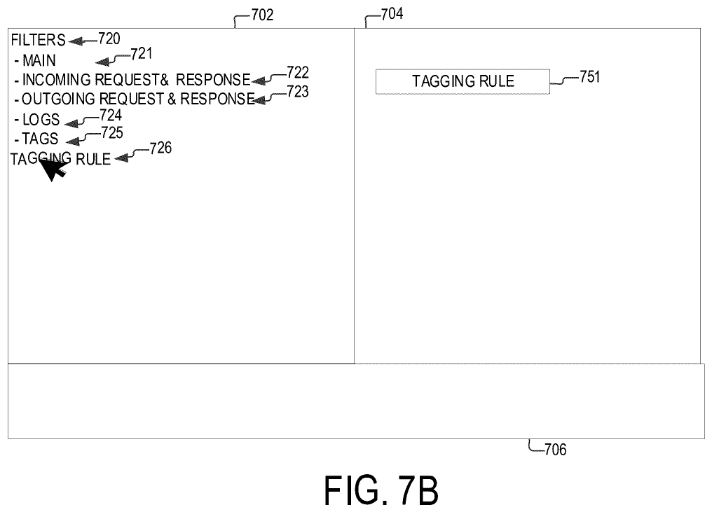

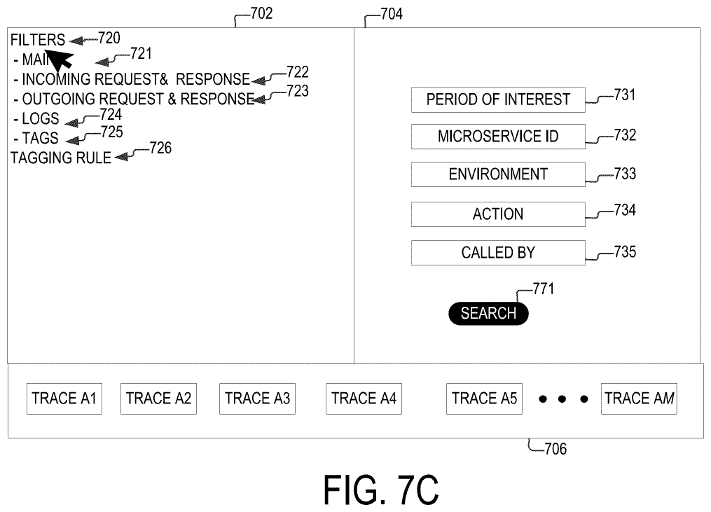

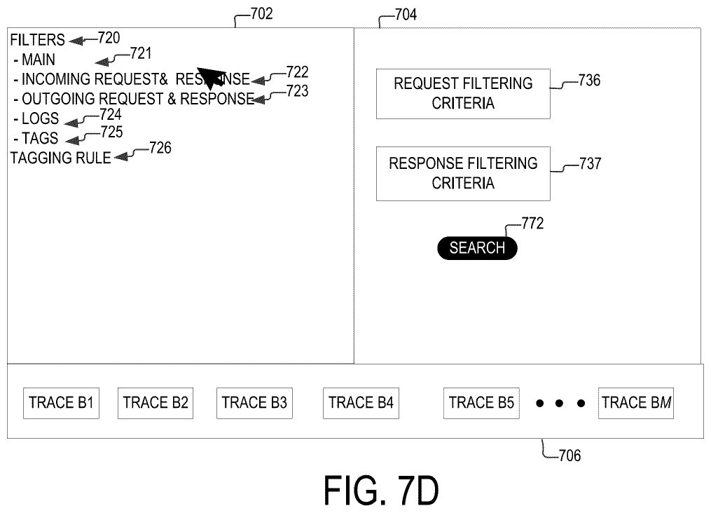

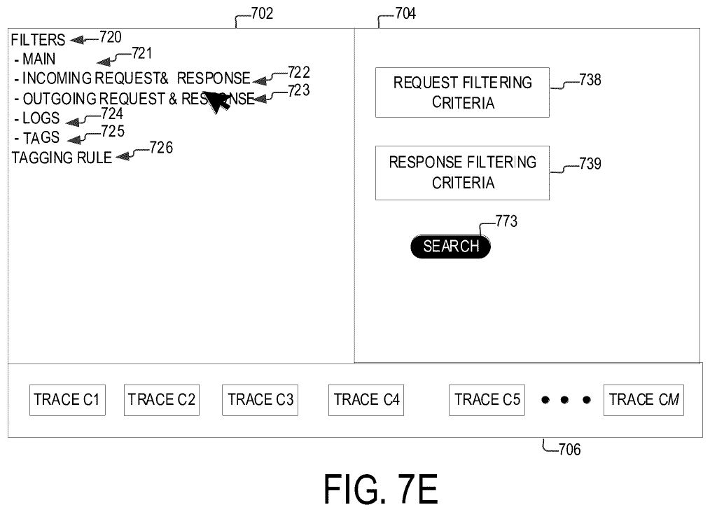

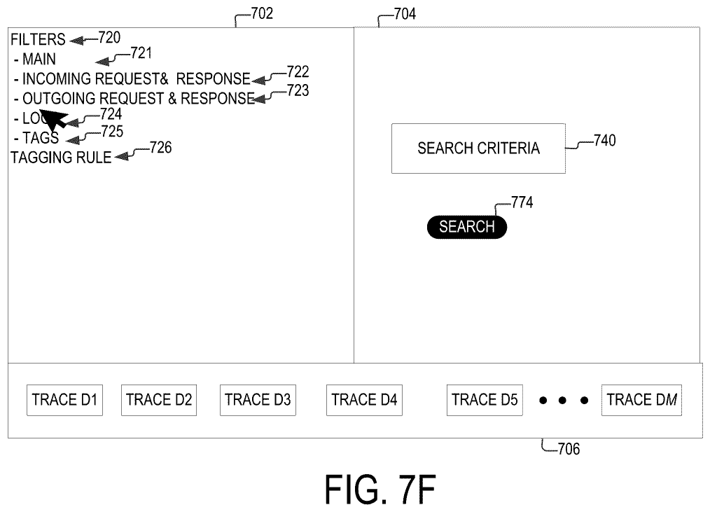

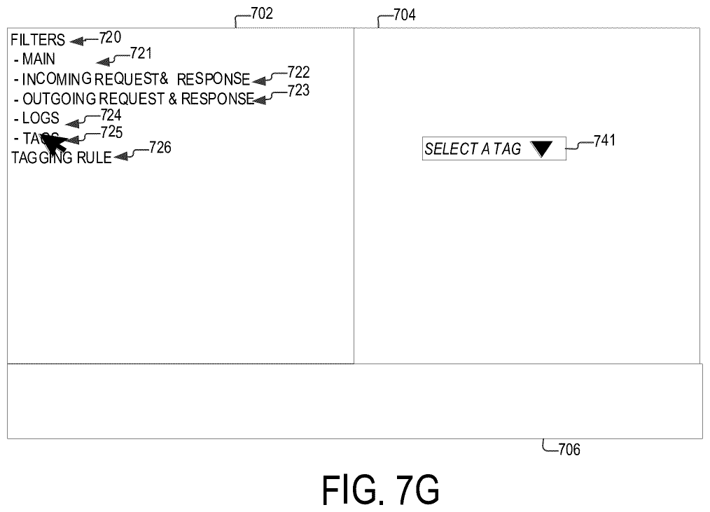

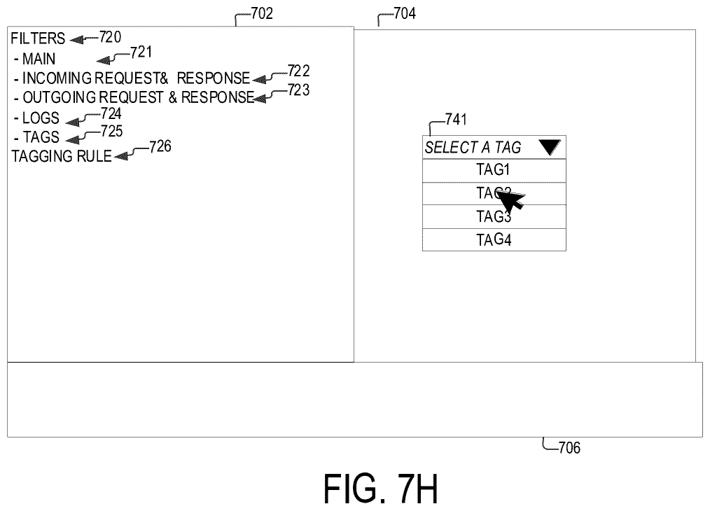

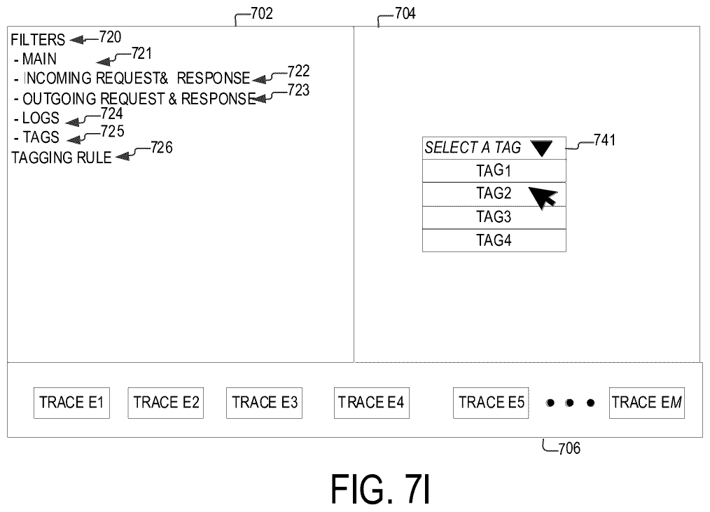

The user interface may include any suitable type of user interface that can be utilized by the user to interact with the data exchange manager. In some implementations, the user interface may be configured to provide functionality for searching traces, analyzing and viewing trace details, exporting trace data, integration with APM tools, trace processing and tagging rules, master data management, configuring the trace collection configuration of the applications, background worker process monitoring, input and specification of application settings, single sign-on, and review of reports and insights. One possible example of the user interface is discussed further below with respect to FIGS. 7A-I.

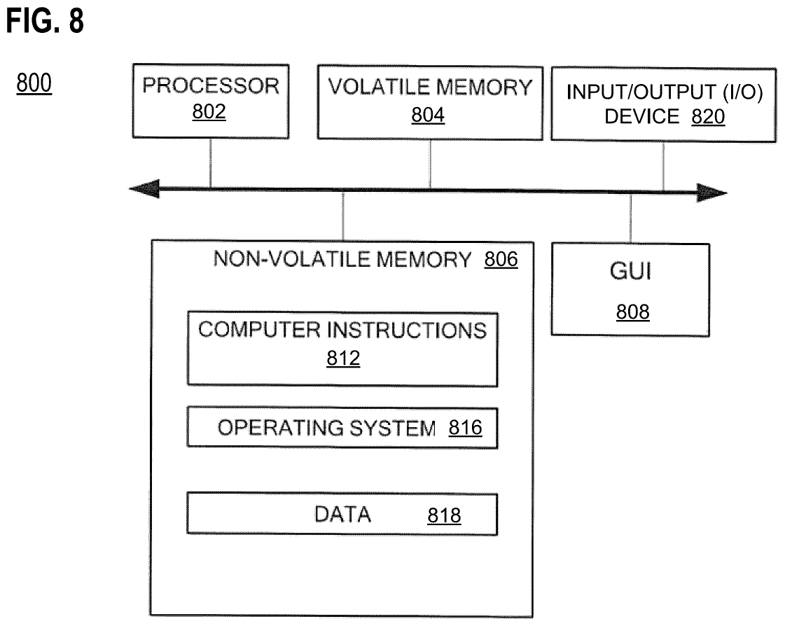

FIG. 1 is a diagram of an example of a system 100, according to aspects of the disclosure. System 100 may include a computing system 110 and a testing system 130. The computing system 110 may include any suitable type of integrated or distributed computing system. Additionally or alternatively, in some implementations, the computing system 110 may include one or more computing devices, such as the computing device 800 which is discussed further below with respect to FIG. 8. The computing system 110 may be configured to execute a microservice suite 112 and a data exchange manager 118. The microservices suite 112 may include a plurality of microservices. The data exchange manager 118 may be configured to process trace logs that are associated with the microservices suite 112. Additionally or alternatively, manager 118 may be configured to feed execution traces (processed or raw) to the testing system 130 for use in replay testing and/or any other suitable type of testing of any of the microservices in microservice suite 112. Although, in the present example, manager 118 is implemented in software, alternative implementations are possible in which at least a portion of the manager 118 is implemented in hardware or as a combination of software or hardware. Testing system 130 may include a continuous integration/continuous delivery (CI/CD) testing system and/or any other suitable type of software testing system.

The computing system 110 may be configured to store an execution trace database 142 (hereinafter “database 142”). The database 142 may include a relational database (e.g., an SQL database), one or more text files (or another type of files), a no SQL database, and/or any other suitable type of database. According to the present example, database 142 includes one or more trace logs that store execution traces that are associated with the microservices in microservice suite 112. However, the present disclosure is not limited to any specific implementation of database 142. Although, in the present example, database 142 is stored in the memory of computing system 110, the present disclosure is not limited to storing the database 142 at any specific location.

The computing system 110 may be configured to store a tagging rule database 144 (hereinafter “database 144”). The database 144 may include a relational database (e.g., an SQL database), one or more text files (or another type of files), a no SQL database, and/or any other suitable type of database. According to the present example, database 144 includes one or more files that store different tagging rules. However, the present disclosure is not limited to any specific implementation of database 144. Although, in the present example, database 144 is stored in the memory of computing system 110, the present disclosure is not limited to storing the database 144 at any specific location.

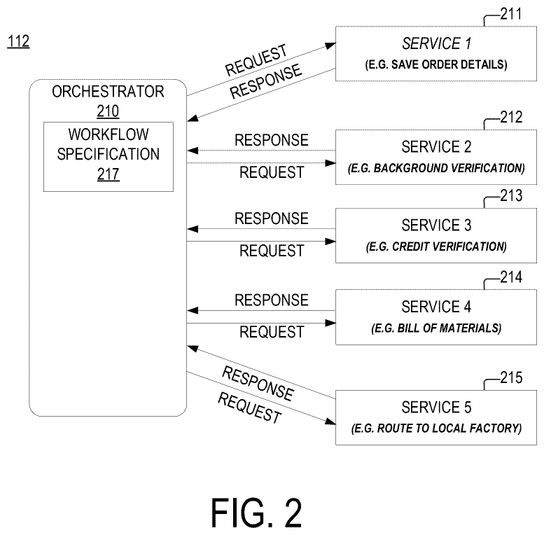

FIG. 2 is a diagram of an example of the microservices suite 112, according to aspects of the disclosure. As illustrated, the microservices suite 112 may include an orchestrator 210 that is configured to execute a microservice sequence in accordance with a workflow specification 217. The workflow specification 217 may include one or more documents and/or objects that specify the order in which the microservices 211-215 have to be executed. The workflow specification 217 may specify that: service 211 has to be executed first; microservice 212 has to be executed second; microservice 213 has to be executed third; microservice 214 has to be executed fourth; and microservice 215 has to be executed last. In operation, the orchestrator 210 may attempt to execute microservices 211-215 in the order that is specified in the workflow specification 217. Executing any of the microservices 211-215 may include transmitting a request to the microservice, and receiving a response that is generated based on the request. The request may be transmitted over a communications network, and the response may be received over the same communications network. The communications network may include one or more of a local area network (LAN), a wide area network (WAN).

According to the present example, microservice suite 112 is part of the backend of an ordering website or system (e.g., a retail website), and each of the microservices 211-215 is arranged to perform a different task related to the operation of the ordering website or system. More particularly, microservice 211 may include a microservice for saving order details that are submitted by a customer. Microservice 212 may include a microservice that is configured to perform background verification of the customer. Microservice 213 may include a microservice that is configured to perform credit verification. Microservice 214 may include a microservice that is configured to create a bill of materials. Microservice 215 may include a microservice that is configured to route the order (and/or a bill of materials) to a selected factory. In some implementations, each of the microservices 215 may be implemented as a separate process. In implementations in which the computing system 110 is a distributed computing system, at least two of the microservices may be executed on different computing devices that are connected via a communications network. It will be understood that FIG. 2 is provided as an example only and the present disclosure is not limited to the microservices 211-215 having any specific implementation or function.

Returning to FIG. 1, manager 118 may include a background worker 114, a graphical user interface (GUI) 120, a predictive analyzer 122, a pattern detector 124, and a testing sequence generator 126.

The background worker 114 may include one or more processes that are configured to tag execution traces in accordance with user-specified tagging rules. In some implementations, each of the microservices 211-215 may have a respective instance of the background worker 114 that is running on the same computing device (or server) as the microservice. The background worker 114 may monitor events that are generated by the microservice. Against each of the events, the background worker 114 may apply a tagging rule that specifies a filtering condition and a tag. If the filtering condition is satisfied, the background worker may generate an execution trace containing both: (1) the tag and (2) information that is part of the event, and store the execution trace in one or more trace logs.

GUI 120 may include any suitable type of graphical user interface. An example of one possible implementation of GUI 120 (or portion thereof) is discussed further below with respect to FIGS. 7A-I.

Predictive analyzer 122 may be configured to identify and label historical request patterns to provide detailed insights into usage and behavioral trends. This informs better decisions about future developments, leading to improved capacity planning, resource allocation, and scalability decisions.

In one example, predictive analyzer 122 may include a neural network (and/or any other suitable type of machine learning model). The neural network may receive as input a signature that encodes information that is part of a sequence of execution traces. The sequence of execution traces may include execution traces that are generated in a particular time window (e.g., during the last 5 minutes, etc.). In some implementations, the sequence of traces may include only a predetermined type of traces (e.g., execution traces that correspond to requests transmitted by the orchestrator 210 and/or execution traces that correspond to responses that are generated by microservices 211-215).

The neural network may classify the signature into one of a plurality of categories that correspond to different outcomes. In one example, the term “outcome” may refer to one of an error condition (or a lack of error condition) that would result from the requests/responses corresponding to the signature. In another example, the term “outcome” refers to one a subsequent request that is expected to be made (e.g., a request that has a high probability of being executed when the requests/responses corresponding to the signature are executed). In yet another example, the term outcome may refer to a particular level of resource utilization (e.g., CPU utilization, memory utilization, etc).

The neural network may include any suitable type of neural network. By way of example, the neural network may be a feedforward neural network (FNN), a convolutional neural network (CNN), a recurrent neural network (RNN), and/or any other suitable type of neural network. In one example, the neural network may be trained using a supervising learning algorithm. The training data used to train the neural network may include a plurality of training data items. Each training data item may include a signature and a label that is indicative of an outcome that corresponds to the signature. Each label may be a number, a string, alphanumerical string that identifies an outcome. Each of the signatures may be a number, a string, or an alphanumerical string that identifies one or more of: (i) a set of a microservices that are part of the sequence, (ii) a set of one or more input parameters that are provided to any of the microservices, (iii) a set of results that are produced by the services. The signature in each of the data items may have the same format as the signatures that are classified by the neural network during the inference stage.

Pattern detector 124 may be configured to identify patterns in the operation of microservices 211-215. Each of microservices 211-215 may have unique characteristics and interactions. In this regard, pattern detector 124 may generate AI-driven reports highlighting how each microservice interacts with others, which endpoints are most frequently accessed based on the requests it receives, and where delays or errors tend to occur. Development teams can understand their service's impact on the overall system and identify opportunities for optimization. Additionally, or alternatively, AI-powered algorithms can recognize patterns in request data, such as usage spikes, specific sequences of requests, or deviations from expected behavior, helping in proactive system management. By analyzing the traces performance bottlenecks, latency issues, and areas where optimizations are needed can be identified.

As used herein, the term AI-powered algorithms refers to algorithms that use artificial intelligence (AI) to analyze data, make decisions, and perform tasks like recommendation systems, image recognition and natural language processing. AI-powered algorithms are well understood by those of ordinary skill in the art. In the present example, since the disclosed system collects messages (message contents, message headers) and telemetry data (request processing duration, time, sequence of calls, etc.), analyses could be done by building AI-powered algorithms to extract valuable information. In the present example, the pattern detector 125 may implement an AI-pattern algorithm that can detect various patterns that are exhibited in messages. For example, pattern detector 125 may detect that a microservice receives certain types of requests on weekdays between 8 AM and 10 AM and responds slower than usual. As another example, pattern detector 125 may detect that one or more of the expected type of requests, the expected number of requests, and/or the contents of requests for a microservice on a weekend day deviate from established historical trends, which might be caused by an unexpected user activity. Additionally or alternatively, pattern detector 124 may be configured to recognize a correlation between request data and system performance and identify performance-related issues/errors. For example, as a result of being configured this way, pattern detector may recognize that a certain message type might be causing the entire request to be processed slower than usual by a microservice. As another example, the pattern detector 124 may be configured to detect that a certain type of payload in a message body causes the microservice to log unexpected errors.

Testing sequence generator 126 may be configured to collect patterns or traces that can reveal patterns of errors, failed requests, and abnormal behavior. By leveraging historical request payloads, new automated payloads can be generated for various functional contexts, improving the overall testing process. These traces can be used for regression testing, helping ensure that changes to services do not negatively impact existing functionality and defects can be routed automatically to the application teams together with trace information for further investigation. Data captured by the testing sequence generator 126 can be used as a data source for regression testing that could be integrated into the pipelines of testing system 130.

In one example, testing sequence generator 126 may detect an event of interest. The event of interest may be an error, an exception, and/or any other similar event. Next, the generator may identify a first set of one or more execution traces that were generated during a first period preceding the event of interest (e.g., the period starting 5 minutes before the event of interest and ending when the event of interest is generated). Next, testing sequence generator 126 may identify a second set of one or more execution traces that were generated during a second period (e.g., the period starting 24 hours before the event and ending 5 minutes before the event). And finally, the generator 126 may provide at least some of the information that is contained in the execution traces in the second set to the testing system. As noted above, the execution traces in the second set may correspond to one or more requests that are transmitted to any of the microservices in the microservice suite 112. In this regard, the testing system 130 may use the information provided by generator 126 to repeat those requests for the purposes of testing and/or debugging microservice suite 112.

In one example, the testing sequence generator 126 may include any suitable type of natural language processing (NLP) model. In operation, the generator 126 may identify a plurality of groups of execution traces (hereinafter candidate sets) that are present in database 142. The groups may be identified by using a brute force approach (e.g., by identifying all or some of all possible combinations of the execution traces in database 142 that correspond to a predetermined time period). For example, when the brute force approach is used, the generator 126 may identify a plurality of groups of N traces (where N is a positive integer) that were generated during a predetermined period (e.g., in the past 24 hours). Next, the generator 216 may generate a different respective signature for the first set and each of the candidate sets. The signature for any of the sets may be generated based on text that is part of the execution traces that constitute the set. The signature may be generated using text2vec or any other suitable technique. Next, the generator may compare the signature of the first set to the respective signature of each of the candidate sets. As a result of the comparison, the generator 126 may obtain a plurality of similarity scores. Each of the similarity scores may correspond to a different candidate set. Each of the similarity scores may be indicative of the degree of similarity between the first set and the candidate score's corresponding candidate set. After the plurality of similarity scores are obtained, the generator 216 may identify those candidate sets whose respective degrees of similarity to the first set exceed a predetermined threshold. And finally, the generator 216 may extract text that is part of the execution traces that are part of the identified candidate sets and provide the extracted text to the testing system 130 for use in texting.

In some implementations, the machine learning model that is part of the generator 126 may be a neural network. The neural network may be configured to receive as input the signature of the first set and the signature of one of the candidate sets and output a similarity score that is indicative of the degree of similarity between the first set and the candidate set. The neural network may include any suitable type of neural network. By way of example, the neural network may be a feedforward neural network (FNN), a convolutional neural network (CNN), a recurrent neural network (RNN), and/or any other suitable type of neural network. In one example, the neural network may be trained using a supervising learning algorithm. The training data used to train the neural network may include a plurality of training data items. Each training data item may include a first signature of one set of execution traces, a second signature of another set of execution traces, and a similarity score for the two sets.

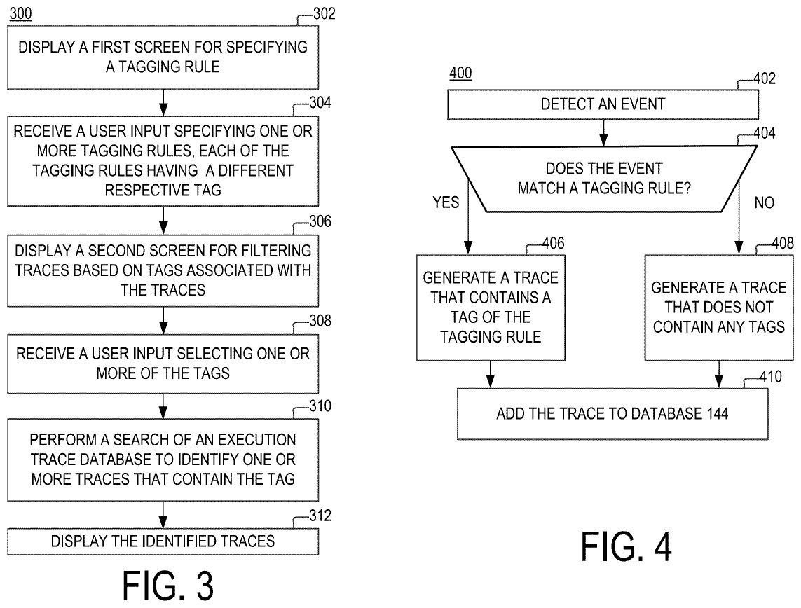

FIG. 3 is a flowchart of an example of a process 300, according to aspects of the disclosure.

At step 302, manager 118 displays a first screen for specifying a tagging rule. The tagging rule may include a tag and a tagging condition. In some implementations, the first screen may include any graphical user interface screen that contains one or more input components for specifying the tagging condition. In some implementations, the first screen may be the same or similar to the screen that is shown in FIG. 7B.

The tagging condition may identify one or more event properties, and a different respective value of the properties. For example, a tagging rule may be: “IF Application==DCQQItemService”. In this example, “Application” is the name of a property of an execution trace belonging to a request, which specifies the name of the microservice that is the recipient of the request. In the same example, the string “DCQQItemService” is the name of a microservice. In the present example, the tagging rule will be satisfied by any event that signals that a request has been submitted to application DCQQItemService. The event that is generated for such a request may identify the application to which the request is submitted, the time when the request is submitted, the opcode for an operation that is invoked by the request, the name of a method that is invoked by the request, one or more input parameters (or arguments) that are submitted to the operation, and so forth. This information may be specified by attribute-value pairs and/or in any other suitable manner. Irrespective of how an event is formatted, a determination of whether a tagging rule is satisfied by the execution can be made by examining the contents of the event. Any information that is part of the event may be included in an execution trace for the event

At step 304, manager 118 receives user input specifying one or more tagging rules. The user input includes keyboard and/or mouse input. The user input is received via the first screen. After the one or more tagging rules are received, each of the tagging rules is stored in the database 144. Each of the tagging rules may have a different respective tag.

At step 306, manager 118 displays a second screen for filtering execution traces in database 142 based on tags that are associated with the traces. The user interface may include a user interface component for selecting any of the tags that are associated with the tagging rules that are specified at step 304 and/or tagging rules that are stored in database 144. In one implementation, the second screen may include a user interface component that identifies the tags. In some implementations, the user interface component may be an output component. In some implementations, the user interface component may include one or more labels or images that are indicative of the tags. Additionally or alternatively, the user interface component may be an input component, such as a drop-down menu, a set of buttons, or a set of radio buttons, etc. In some implementations, the second screen may be the same or similar to the screens that are shown in FIGS. 7G-I.

According to the present example, displaying the user interface component may include performing a search of the database 144 to identify a plurality of tagging rules that are stored in the database 144; parsing each of the identified tagging rules to identify the respective tag of the tagging rule; and populating the user interface component with the identified tags. For example, if the user input component is a drop-down menu, populating the user interface component with the identified tags may include providing the tags to a constructor or another method of the drop-down menu so as to cause the drop-down menu to include the tags. For example, if the user input component is a drop-down menu, populating the user interface component with the identified tags may include providing the tags to a constructor or another method of the drop-down menu so as to cause the drop-down menu to include the tags. As another example, if the user input component is a label or a set of labels, populating the user interface component with the identified tags may include providing the tags to a constructor or another method of the label (or set of labels) so as to cause the label or set of labels to include the tags.

At step 308, manager 118 receives user input selecting one of the tags that are presented in the second screen. In one example, the second input may include a mouse click selecting one of the tags that are displayed in drop-down menu or a radio button. In another example, the second input may be a mouse click on a button. In yet another example, the user input may be a voice input. In yet another example, the user input may be a keyboard input. Stated succinctly, the present disclosure is not limited to any specific type of user input being received.

At step 310, manager 119 performs a search of the database 142 to identify any execution traces that contain the tag selected at step 308.

At step 312, manager 118 displays the identified execution traces. In some implementations, the execution traces may be displayed in a screen, such as the screen that is shown in FIG. 7I. Displaying the execution traces may include displaying an identifier of any of the execution traces. Additionally or alternatively, displaying the execution traces may include displaying for each of the identified execution traces a link, button, or another active user interface input component, which, when activated, causes the entire contents of the execution trace to be displayed. It will be understood that the present disclosure is not limited to any specific method for displaying execution traces.

FIG. 4 is a flowchart of an example of a process 400, according to aspects of the disclosure. According to the present example, process 400 is performed by background worker 114. However, the present disclosure is not limited to any specific entity executing the process 400.

At step 402, background worker 114 detects that an event is generated. The event may include any suitable type of event that is generated by orchestrator 210 and/or any of microservices 211-215. In one example, the event may be generated in response to the transmission (or receipt) of a request by the orchestrator 210 or any of the microservices 211-215. Additionally or alternatively, the event may be generated in response to the transmission (or receipt) of a request by the orchestrator 210 or any of the microservices 211-215. Additionally or alternatively, the event may be generated in response to the generation of an error or exception by the orchestrator 210 or any of the microservices 211-215.

When the event corresponds to a request, the event may include any information associated with the request. Such information may include: the application (or microservice) to which the request is submitted, the time when the request is submitted, the opcode for an operation that is invoked by the request, the name of a method that is invoked by the request, one or more input parameters (or arguments) that are submitted to the operation or method, and so forth.

When the event corresponds to a response, the event may include any information associated with the response. Such information may include: the application (or microservice) or microservice that generated the response, the time when the response is submitted, the opcode for an operation that generated the response, the name of a method that generated the response, and/or any other information that is part of the response.

When the event corresponds to an error or exception, the event may include any information associated with the event or error. Such information may include: the application (or microservice) or microservice that generated the event or error, the time when the event or error was generated, the opcode for an operation that generated the event or error, the name of a method that generated the event or error, and/or any other information that is part of the event or error.

At step 404, background worker 114 detects whether the event matches any of the tagging conditions that are stored in database 144. As noted above, the tagging rule may include a tagging condition and a tag. The event may be considered to match the tagging rule if the event satisfies the condition. If the event matches the tagging rule, process 400 proceeds to step 406. Otherwise, if the event does not match the tagging rule, process 400 proceeds to step 408.

At step 406, background worker 114 generates an execution trace for the event. The execution trace may include one or more alphanumeric strings that encode or otherwise include at least some of the information that is part of the event. In addition, the event includes the tag for the tagging rule that is evaluated at step 404. The tag may be concatenated to the one or more strings or otherwise associated with the one or more strings. In the present example, only one tagging rule is evaluated. However, in alternative implementations, more than one of the tagging rules stored in database 144 may be evaluated. In such implementations, the respective tag for each tagging rule that matches the event may be added to the event. As noted above, the term “tag” as used herein may refer to a user-specified label that is artificially added to an execution trace for the purpose of tracking or filtering the trace later. The tag, in one example, may be a word or a note that has a meaning to a developer and which would signal to the developer that the tag is associated with a particular entity or problem.

At step 408, background worker 114 generates an execution trace for the event. The execution trace may include one or more alphanumeric strings that encode or otherwise include at least some of the information that is part of the event. However, because the event does not match the tagging rule, the execution trace that is generated for the event would not include the tag of the tagging rule. In general, the tag may be any suitable type of number, string, or alphanumerical string.

At step 410, the execution trace generated at steps 406/408 is added to database 144.

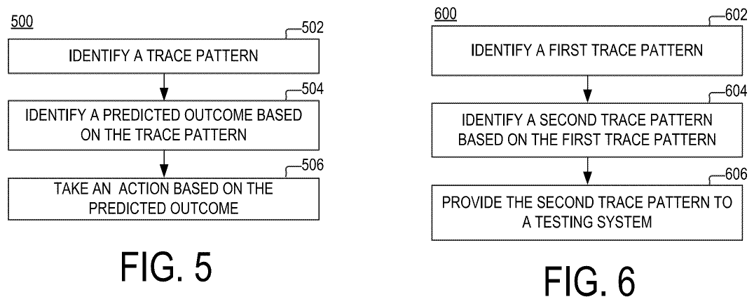

FIG. 5 is a flowchart of an example of a process 500, according to aspects of the disclosure. According to the present example, process 500 is performed by predictive analyzer 122. However, the present disclosure is not limited to being performed by any specific type of entity. At step 502, predictive analyzer 122 identifies a trace pattern. The trace pattern may include any suitable type of trace pattern. In some implementations, the trace pattern may be identified in the manner discussed above. At step 504, the predictive analyzer 122 identifies an outcome based on the trace pattern. The outcome may be identified in the manner discussed above with respect to FIG. 1. At step 506, predictive analyzer 122 takes an action based on the outcome. As noted above, in one example, the trace pattern may include execution traces that correspond to requests to add items to a shopping cart. The outcome may be another execution request that adds an additional item to the shopping cart. The action based on the outcome may include presenting the user with a recommendation for purchasing the additional item. As noted above, the trace pattern may include a set of N most recently recorded execution traces, where N is a positive integer. The outcome may be a utilization level for a particular resource (e.g., memory, CPU time, etc.). The action based on the outcome may be allocating additional capacity of the resource (e.g., allocating additional memory or additional CPU time) in response to the level exceeding a threshold.

FIG. 6 is a flowchart of an example of a process 600, according to aspects of the disclosure. According to the present example, process 600 is performed by generator 126. However, the present disclosure is not limited to any specific entity executing the process 600. At step 602, generator 126 identifies a first pattern of execution traces. The first pattern may be a pattern associated with an error or exception or a pattern specified by the user. At step 604, generator 126 identifies a second pattern that matches the first pattern. The second pattern may be identified in the manner discussed above with respect to FIG. 1. At step 606, at least some of the information that is part of the execution traces constituting the second pattern is provided to the testing system 130.

FIGS. 7A-I shows an example of one possible example of GUI 120, according to aspects of the disclosure. In the example of FIG. 7A-I, the GUI 120 enables to user to specify filtering criteria and tagging rules. As used herein, the term “input component” may refer to any suitable type of graphical user interface component, such as a button, a text field, a checkbox, a radio button menu, a drop-down menu, a clickable text label, etc. It will be understood that the present disclosure is not limited to using any specific type of input component. Furthermore, it will be understood that the present disclosure is not limited to the implementation of GUI 120 that is shown in FIGS. 7A-I.

FIG. 7A illustrates that GUI 120 may include portions 702, 704, and 706. Portion 702 may be configured to display a navigation menu 720 that includes input components 721-726.

FIG. 7B shows the state of GUI 120 when input component 726 is activated (e.g., clicked, etc.). FIG. 7B illustrates that when input component 726 is activated, one or more input components 751 are displayed in portion 704, which are configured to receive user input that specifies a tagging rule. The one or more input components 751 may be the same type or different types of input components. For example, the one or more input components 751 may include one or more text fields (or pre-populated menus) that are configured to receive a tagging condition, a text field that is configured to receive user input specifying a tag, and a submit button, which, when activated, causes data exchange manager 118 to generate an indication of a tagging rule that includes the tagging condition and tag, and store the indication in database 142.

FIG. 7C shows the state of GUI 120 when input component 721 is activated (e.g., clicked, etc.). FIG. 7C illustrates that when input component 721 is activated, input components 731-735 may be displayed, along with input component 771 (e.g., a search button), in portion 704. Input components 731 may include one or more input components for specifying a period of interest. Input components 732 may include one or more input components for specifying a microservice ID value. Input component 733 may include or more components for specifying an environment ID value (e.g., the ID of a production environment or a testing environment, etc). Input component 734 may include one or more components for specifying an action ID value (e.g., the ID of an action). Input component 734 may include one or more input components for specifying a called-by-value (e.g., the ID of a microservice or another entity that called the microservice identified by the microservice ID value of input component 732).

As noted above, input components 731-735 may be used to receive input specifying a filtering condition. Specifically, input components 731-735 may be used to specify the values of respective properties of one or more execution traces. If an execution trace has properties whose values match the values specified by input components 731-735, the execution trace is said to match the filtering condition. Activating input component 771 may cause the manager 118 to perform a search of database 142 to identify all execution traces in database 142 that match the filtering condition. Afterwards, the identified execution traces are displayed. According to the present example, execution traces A1-AM are identified as a result of the search and displayed in portion 706 of GUI 120.

FIG. 7D shows the state of GUI 120 when input component 722 is activated (e.g., clicked, etc.). FIG. 7D illustrates that when input component 722 is activated, input components 736-737 may be displayed in portion 704, along with an input component 772 (e.g., a search button). Input component 736 may include one or more input components for specifying the values of properties of execution traces that correspond to incoming requests. Specifically, input component 736 may be used to specify one or more of a method (or opcode) that is associated with the incoming request, the ID of a microservice by which the request is made, a uniform resource locator (URL) that is part of the incoming request, one or more header field values that are part of the incoming request, and/or a key for searching the body of the incoming request. Input component 737 may include one or more input components for specifying the values of properties of execution traces that correspond to incoming responses. Specifically, input component 737 may be used to specify one or more of a status code for the response, a latency of the incoming response, one or more header field values that are part of the incoming response, a key for searching the body of the incoming response, and/or the ID of a microservice or other entity that transmitted that the response. According to the example of FIG. 7D, after user input is provided to input components 736 and 737, input component 772 is activated (e.g., pressed). Activating input component 772 may cause the manager 118 to perform a search of database 142 to identify the execution traces for incoming requests and responses (e.g., incoming to computing system 110) that have the properties specified via input components 736 and 737. The identified execution traces may be displayed in portion 706. According to the present example, execution traces B1-BM are identified as a result of the search and displayed in portion 706 of GUI 120.

FIG. 7E shows the state of GUI 120 when input component 723 is activated (e.g., clicked, etc.). FIG. 7E illustrates that when input component 723 is activated, input components 738-739 may be displayed in portion 704, along with an input component 773 (e.g., a search button). Input component 738 may include one or more input components for specifying the values of properties of execution traces that correspond to outgoing requests. Specifically, input component 738 may be used to specify one or more of a method (or opcode) that is associated with the outgoing request, the ID of a microservice to which the request is made, a uniform resource locator (URL) that is part of the outgoing request, one or more header field values that are part of the outgoing request, and/or a key for searching the body of the outgoing request. Input component 739 may include one or more input components for specifying the values of properties of execution traces that correspond to outgoing responses. Specifically, input component 739 may be used to specify one or more of a status code for the response, a latency of the outgoing response, one or more header field values that are part of the outgoing response, the ID of a microservice or other entity to which the request is transmitted, and/or a key for searching the body of the outgoing response. According to the example of FIG. 7E, after user input is provided to input components 738 and 739, input component 773 is activated (e.g., pressed). Pressing search button 773 may cause the manager 118 to perform a search of database 142 to identify the execution traces for outgoing requests and responses (e.g., outgoing from computing system 110) that have the properties specified via input components 738 and 739. The identified execution traces may be displayed in portion 706. According to the present example, execution traces C1-CM are identified as a result of the search and displayed in portion 706 of GUI 120.

FIG. 7F shows the state of GUI 120 when input component 724 is activated (e.g., clicked, etc.). FIG. 7F illustrates that when input component 724 is activated, one or more input components 740 may be displayed in portion 704, along with an input component 774 (e.g., a search button). Input components 740 may include one or more input components for specifying a filtering condition for execution traces that correspond to events other than requests and responses. For example, input component 740 may include execution traces that correspond to events or errors, and/or any other suitable type of execution trace. For example, input component 740 may arranged to specify one or more of: an error code or exception code, the ID of a microservice that generated the error/exception, the ID of a method that generated the error/exception, a key for searching the body of the error/exception, etc. Activating (e.g., pressing) input component 774 may cause the manager 118 to perform a search of database 142 to identify the execution traces that match the filtering condition (e.g., execution traces that possess the properties specified by the filtering condition) that is input by using input components 740. The identified execution traces may be displayed in portion 706. According to the present example, execution traces D1-DM are identified as a result of the search and displayed in portion 706 of GUI 120.

FIG. 7G shows the state of GUI 120 when input component 725 is activated (e.g., clicked, etc.). FIG. 7G illustrates that when input component 724 is activated, an input component 741 may be displayed in portion 704. According to the present example, input component 741 is a drop-down menu, however the present disclosure is not limited thereto. According to the present example, the drop-down menu is populated with a plurality of tags, wherein each of the plurality of tags is part of a different one of the tagging rules that are stored in database 144. FIG. 7H shows the state of GUI 120 when the drop-down menu 741 is expanded and a selection is made of one or more of the tags in the drop-down menu 741. FIG. 7I shows the state of GUI 120 after the selection from the drop-down menu 741. FIG. 7I illustrates that in response to making a selection from drop-down menu 741, manager 118 may perform a search of database 144 to identify execution traces that contain the selected tag, after which the identified executing traces may be displayed in portion 706. According to the present example, execution traces E1-EM are identified as a result of the search and displayed in portion 706 of GUI 120.

FIGS. 7A-I provide examples of GUI screens that can be used to specify different search criteria. For ease of description, each of the screens is provided with a different search button, which, when activated, causes a search of database 142 to be performed based only on the condition that is specified in this screen. However, in alternative implementations, a single (or “shared”) search button may be provided for multiple ones of the screens shown in FIGS. 7A-I. In such implementations, when the shared search button is activated, a search of database 142 may be performed based on a plurality of search criteria, wherein each of the search criteria is specified in a different one of the screens that share the search button.

FIGS. 1-7I are provided as an example only. In some embodiments, the term “I/O request” or simply “I/O” may be used to refer to an input or output request. In some embodiments, an I/O request may refer to a data read or write request. At least some of the steps discussed with respect to FIGS. 1-7I may be performed in parallel, in a different order, or altogether omitted. As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard. (1/23)

It will be further understood that various changes in the details, materials, and arrangements of the parts which have been described and illustrated in order to explain the nature of the claimed invention might be made by those skilled in the art without departing from the scope of the following claims.

1. A method, comprising:
displaying a first screen for specifying one or more tagging rules for a microservice;
receiving, via the first screen, a first user input specifying a tagging rule, the tagging rule including a tag and a tagging condition that needs to be satisfied by an execution trace in order for the respective tag to be appended to the execution trace;
displaying a second screen for specifying one or more filtering criteria, the second screen including an input component that is populated with the respective tag;
receiving a second user input specifying a filtering condition, the second user input being received, at least in part, via the second screen; and
displaying a list of execution traces that satisfy the filtering condition.

2. The method of claim 1, further comprising, storing the tagging rule in a memory, wherein populating the input component with the tag includes performing a search of the memory to identify the tagging rule and inserting the tag in the input component.

3. The method of claim 1, further comprising:
detecting an event that is associated with the microservice;
obtaining an execution trace that is associated with the event;
detecting whether the execution trace satisfies the tagging condition;
inserting the tag in the execution trace when the tagging condition is satisfied; and
abstaining from inserting the tag in the execution trace when the tagging condition is not satisfied.

4. The method of claim 3, wherein the detecting of whether the execution trace satisfies the tagging condition is performed in real time or near-real time with respect to the event.

5. The method of claim 1, wherein the filtering condition specifies one or more general characteristics which any given execution trace must possess in order for the filtering condition to be satisfied by the given execution trace.

6. The method of claim 1, wherein the filtering condition is limited to execution traces of requests and/or execution traces of responses, and the filtering condition specifies one or more request-response characteristics, each of the request-response characteristics being a characteristic which any given execution trace for a request or response must possess in order for the filtering condition to be satisfied by the give execution trace.

7. The method of claim 1, further comprising:
identifying a first execution trace pattern, the first execution trace pattern including a plurality of first execution traces;
identifying a second execution trace pattern that matches the first execution trace pattern, the second execution trace pattern including a plurality of second execution traces;
extracting at least some of contents of the plurality of second execution traces; and
providing the extracted contents to a testing system.

8. The method of claim 7, wherein the first execution trace pattern is associated with an error or an exception.

9. A system, comprising:
a memory; and
at least one processor that is operatively coupled to the memory, the at least one processor being configured to perform the operations of:
displaying a first screen for specifying one or more tagging rules for a microservice;
receiving, via the first screen, a first user input specifying a tagging rule, the tagging rule including a tag and a tagging condition that needs to be satisfied by an execution trace in order for the respective tag to be appended to the execution trace;
displaying a second screen for specifying one or more filtering criteria, the second screen including an input component that is populated with the respective tag;
receiving a second user input specifying a filtering condition, the second user input being received, at least in part, via the second screen; and
displaying a list of execution traces that satisfy the filtering condition.

10. The system of claim 9, wherein the at least one processor is further configured to perform the operation storing the tagging rule in the memory, wherein populating the input component with the tag includes performing a search of the memory to identify the tagging rule and inserting the tag in the input component.

11. The system of claim 9, wherein the at least one processor is further configured to perform the operations of:
detecting an event that is associated with the microservice;
obtaining an execution trace that is associated with the event;
detecting whether the execution trace satisfies the tagging condition;
inserting the tag in the execution trace when the tagging condition is satisfied; and
abstaining from inserting the tag in the execution trace when the tagging condition is not satisfied.

12. The system of claim 11, wherein the detecting of whether the execution trace satisfies the tagging condition is performed in real time or near-real time with respect to the event.

13. The system of claim 9, wherein the filtering condition specifies one or more general characteristics which any given execution trace must possess in order for the filtering condition to be satisfied by the given execution trace.

14. The system of claim 9, wherein the filtering condition is limited to execution traces of requests and/or execution traces of responses, and the filtering condition specifies one or more request-response characteristics, each of the request-response characteristics being a characteristic which any given execution trace for a request or response must possess in order for the filtering condition to be satisfied by the given execution trace.

15. The system of claim 9, wherein the at least one processor is further configured to perform the operations of:
identifying a first execution trace pattern, the first execution trace pattern including a plurality of first execution traces;
identifying a second execution trace pattern that matches the first execution trace pattern, the second execution trace pattern including a plurality of second execution traces;
extracting at least some of contents of the plurality of second execution traces; and
providing the extracted contents to a testing system.

16. The system of claim 15, wherein the first execution trace pattern is associated with an error or an exception.

17. A method, comprising:
identifying a first execution trace pattern, the first execution trace pattern including a plurality of first execution traces;
identifying a second execution trace pattern that matches the first execution trace pattern, the second execution trace pattern including a plurality of second execution traces;
extracting at least some of contents of the plurality of second execution traces; and
providing the extracted contents to a testing system.

18. The method of claim 17, wherein the first execution trace pattern is associated with an error or an exception.

19. The method of claim 17, wherein the execution trace pattern is identified based on a user input.

20. The method of claim 17, further comprising:
displaying a first screen for specifying one or more tagging rules for a microservice;
receiving, via the first screen, a first user input specifying a tagging rule, the tagging rule including a tag and a tagging condition that needs to be satisfied by an execution trace in order for the respective tag to be appended to the execution trace;
displaying a second screen for specifying one or more filtering criteria, the second screen including an input component that is populated with the respective tag;
receiving a second user input specifying a filtering condition, the second user input being received, at least in part, via the second screen; and
displaying a list of execution traces that satisfy the filtering condition.
